(19) United States
(12) Patent Application Publication
(10) Pub. No.: US 2016/0236198 A1
(43) Pub. Date: Aug. 18, 2016

(54) GYRATORY CRUSHER BOTTOM SHELL ASSEMBLY AND ARM LINERS

(71) Applicant: SANDVIK INTELLECTUAL PROPERTY AB, Sandviken (SE)

(72) Inventors: Zeljko NIKOLIC, Svedala (SE); Anders HALLBERG, Sodra Sandby (SE); Mikael M. LARSSON, Eslov (SE); Bengt-Arne ERIKSSON, Svedala (SE); Axel BERGMAN, Malmo (SE); Patric MALMQVIST, Svedala (SE)

(21) Appl. No.: 15/028,126

(22) PCT Filed: Sep. 22, 2014
(86) PCT No.: PCT/EP2014/070109

§ 371 Date: Apr. 8, 2016

(30) Foreign Application Priority Data
Oct. 11, 2013 (EP) 13188207.8

(51) Int. Cl. B02C 2/00; B02C 2/04

(52) U.S. Cl. CPC B02C 2/005; B02C 2/04

(57) ABSTRACT

A gyratory crusher bottom shell and/or bottom shell assembly include protective liners that are mounted over and about respective support arms that extend radially between the bottom shell wall and a central hub. The support arms have a seat or saddle region with at least a part of the liner positioned in contact with and supported by the seat to distribute the mass of the liner radially between the hub and the shell wall and to reduce tension in the primary attachment bolts.

### FIELD OF INVENTION

The present invention relates to a gyratory crusher bottom shell and a bottom shell assembly in which support arms that extend radially to mount a central hub of the bottom shell are shaped and/or configured to provide a seat to at least partially accommodate respective arm liners to provide a secure and effective means of mounting the liners at the bottom shell.

### BACKGROUND ART

Gyratory crushers are used for crushing ore, mineral and rock material to smaller sizes. Typically, the crusher comprises a crushing head mounted upon an elongate main shaft. A first crushing shell is mounted on the crushing head and a second crushing shell is mounted on a frame such that the first and second crushing shells define together a crushing chamber through which the material to be crushed is passed.

The gyratory pendulum movement of the crushing head is supported by a lower bearing assembly positioned below the crushing head and a top bearing into which an upper end of the main shaft is journalled. The main shaft and lower bearing are typically mounted within a central hub supported at the bottom shell by radially extending arms. These support arms and the radially inward facing surface of the bottom shell are protected from the material as it falls through the bottom shell by wear resistant liner plates. Example protective liners are described in U.S. Pat. No. 2,860,837; U.S. Pat. No. 3,150,839; U.S. Pat. No. 4,065,064.

However, existing bottom shells and arm liners are disadvantageous for a number of reasons. Firstly, it is conventional for the liners to be supported exclusively by attachment bolts that secure radially outer parts of the arm liner to the bottom shell wall to suspend the liner above the support arm. Conventionally, the bottom shell support arms are angled downwardly from the shell wall to the central hub such that if the attachment bolts fail the liner falls radially inward to the hub and becomes dislodged from the arm. According to the conventional arrangements, the attachment bolts are required to both withstand the significant impact forces resultant from the contact with material as it falls through the bottom shell and support the arm liner in a complete or partial cantilever arrangement. Secondly, conventional arm liners, due in part to the configuration of the support arms, are angled axially downward towards the hub. This is disadvantageous as material is thrown radially inward towards the hub resulting in wear to both the hub and associated seals and dust collars. Accordingly, what is required is a bottom shell and bottom shell liner assembly that addresses the above problem.

### SUMMARY OF THE INVENTION

It is an objective of the present invention to provide a gyratory crusher bottom shell and a bottom shell assembly (including a plurality of support arm liners) that is configured to reliably and efficiently mount the support arm liners to both reduce the tensile force within the attachment bolts and to ensure the support arm liners are provided with a redundancy seated position in the event that the attachment bolts fail so as to retain the liners at the support arms. It is a further specific objective to configure the arm liners for the desired and efficient deflection of material passing through the bottom shell without deflecting a majority component of the material radially inward to the central hub. A stronger more reliable means of mounting support arm liners is desired.

The objectives are achieved, by specifically configuring the shape and configuration of the support arms that extend radially between the lower region of the shell wall and the central hub. In particular, an axially upper region (or surface) of each arm comprises a trough, seat or saddle region that is positioned axially below an axially uppermost part of the hub so as to accommodate at least a part of the arm liner. In such a configuration, the liner nestles within the seat and is capable of being supported exclusively by the contact with the seat. Accordingly, the present arrangement is advantageous to distribute the mass of the liner in a radial direction between the hub and the shell wall and to reduce the support loading at the radially outer attachment bolts that secure the arm liner to the bottom shell. According to the present configuration, the arm liner is supported both at or towards its radially innermost region and its radially outermost region. Supporting the liner via a dip or recess positioned at a radially inner region of the arm is beneficial to prevent the liner from becoming completely dislodged from the arm should the attachment bolts fail.

The present configuration is further advantageous in that the recess or seat enables an uppermost surface of the arm liner (that contacts the material falling through the bottom shell) to be ‘less inclined’ than existing liner arrangements and to extend in a horizontal or near horizontal plane to avoid undesirable deflection of material towards the central hub. The present arrangement therefore allows a significant part of the radial length of the liner to be positioned at, below or slightly above an uppermost part of the hub.

According to a first aspect of the present invention there is provided a gyratory crusher bottom shell assembly comprising: an outer wall extending around a longitudinal axis, the wall having radially outer and inner facing surfaces; an inner hub positioned radially within the wall and surrounded by a part of the inner facing surface; a plurality of support arms extending radially to connect the wall and the hub, each arm having an axially upward facing surface that extends generally axially downward from the inner facing surface of the wall towards the hub at a radially outer section of the arm, the upward facing surface at a radially inner section of the arm extending generally axially upward to mate with the hub wherein a region of the upward facing surface is positioned axially lower than an axially uppermost end surface of the hub to define a seat; a plurality of arm liners positioned over the respective arms, each liner having an upward facing surface capable of contacting material passing through the bottom shell assembly and an underside surface positioned opposed to the upward facing surface of the arm; characterised in that: each of the liners comprises a shape and configuration such that a part of the underside surface of the liner is in contact with the upward facing surface of the arm at the seat to at least partially mount each of the liners at the respective arms.

Preferably, the seat comprises a curved shape profile in a radial direction between the wall and the hub. Advantageously, the upward facing surface of the arm slopes gradually downward towards the seat (or recess) from the shell wall and slopes gradually upward from the seat towards the central hub. Such a configuration provides a saddle region at the support arm that encourages the liner to be ‘self-seating’ into the saddle in the event that the attachment bolts fail.

Optionally, the seat is positioned radially closer to the hub than the wall. Such an arrangement is further advantageous to prevent the liner from becoming dislodged from the arm and to be retained at the bottom shell.

Preferably, in an axial plane extending along the radial length of each arm, a radial length (B) of the seat is in a range 30 to 90% of a radial distance (A) between a radially outermost part of the uppermost end surface of the hub and the outer facing surface of the wall at an axial position coplanar with said uppermost end surface. Accordingly, the present radial length of the seat ensures a majority of the radial length of the liner is supported by the seat region to be stabilised over the majority of the liner radial length. Preferably, this range is 40 to 80%; 45 to 65%; 48 to 60%; and more preferably 53 to 57%.

Optionally, in an axial plane extending along a radial length of each arm, a radial length (B) of the seat is in a range 50 to 100% of a radial length (C) of the respective liner extending in the direction between the wall and the hub. Optionally, said range of said length of the seat to the length of the liner is 65 to 90%.

Optionally, in an axial plane extending along a radial length of each arm, a radial length (D) of the liner occupied within the seat is in a range 10 to 80%. More preferably, said range is 30 to 70%; 40 to 60%; or 45 to 55%. The respective radial lengths of the liner and seat region are advantageous to i) distribute the mass of the liner along the support arm, ii) provide the required deflection direction of material passing through the bottom shell and iii) provide a means for the secure seating of the liner at the arm in the event of failure of the primary attachment bolts.

According to a second aspect of the present invention there is provided a gyratory crusher bottom shell comprising: an outer wall extending around a longitudinal axis, the wall having radially outer and inner facing surfaces; an inner hub positioned radially within the wall and surrounded by a part of the inner facing surface; a plurality of support arms extending radially to connect the wall and the hub, each arm having an axially upward facing surface that extends generally axially downward from the inner facing surface of the wall towards the hub at a radially outer section of the arm, the upward facing surface at a radially inner section of the arm extending generally axially upward to mate with the hub wherein a region of the upward facing surface is positioned axially lower than an axially uppermost end surface of the hub to define a seat; characterised in that: in an axial plane extending along the radial length of each arm, a radial length (B) of the seat is in a range 30 to 90% of a radial distance (A) between a radially outermost part of the uppermost end surface of the hub and the outer facing surface of the wall at an axial position coplanar with said uppermost end surface.

Optionally, the radial length of the liner occupied within the seat is in the range 30 to 70%. Preferably, the range of the radial length (B) to the radial distance (A) is 40 to 80%; 45 to 65%; 48 to 60%; and more preferably 53 to 57%. Optionally, the seat is positioned radially closer to the hub and the wall and the seat comprises a curved shape profile in a radial direction between the wall and the hub.

### BRIEF DESCRIPTION OF DRAWINGS

A specific implementation of the present invention will now be described, by way of example only, and with reference to the accompanying drawings in which:

FIG. 1 is a perspective view of a gyratory crusher bottom shell having a modular wear resistant liner positioned internally within the bottom shell to protect both the internal surface of the shell and support arms that extend radially between the shell wall and a central hub that mounts the crusher main shaft and part of the drive components according to a specific implementation of the present invention;

FIG. 2 illustrates the bottom shell and protection liner assembly of FIG. 1 with one of the protective arm liners removed for illustrative purposes;

FIG. 3 is a cross section through E-E of FIG. 2;

FIG. 4 is a magnified view of the cross section through E-E with the protective arm liner in position over and about the arm;

FIG. 5 is a perspective view of the arm liner of FIG. 4;

FIG. 6 is a further perspective view of the arm liner of FIG. 5;

FIG. 7 is the cross sectional view of FIG. 4 further including indicated relative radial dimensions of both the arm and the protective arm liner according to a specific implementation of the present invention.

### DETAILED DESCRIPTION OF PREFERRED EMBODIMENT OF THE INVENTION

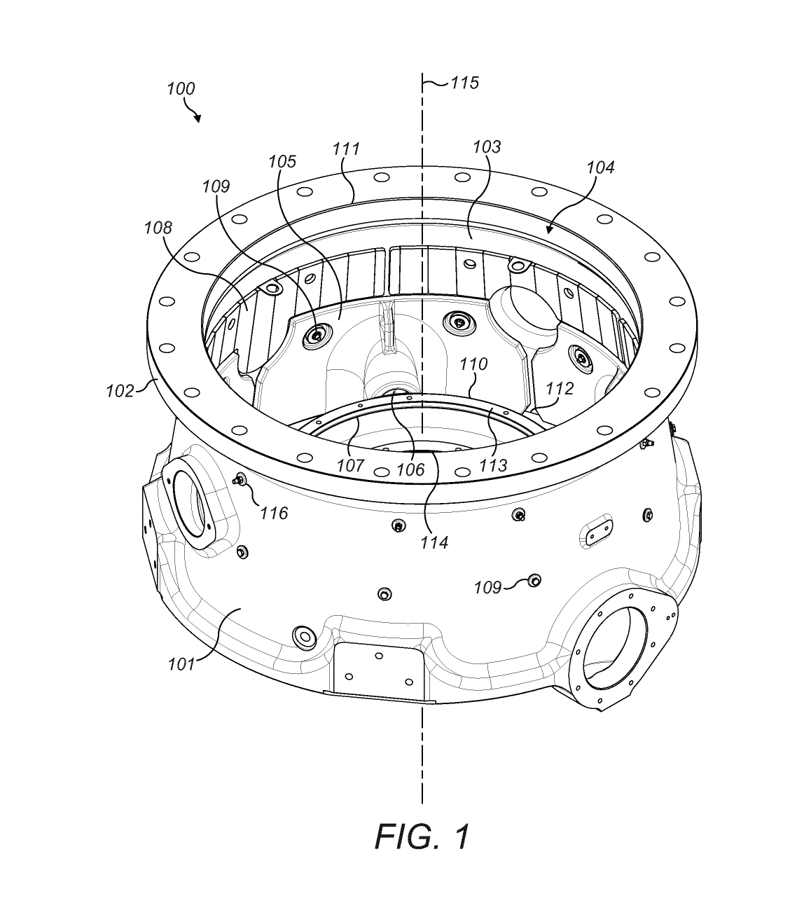

Referring to FIG. 1, a gyratory crusher bottom shell 100 comprises a bottom shell wall 101 extending circumferentially around a central longitudinal axis 115. Wall 101 comprises an axially uppermost annular end 111 and a lowermost annular end 112. In particular, an annular rim 102 projects radially outward from wall 101 at upper end 111 to provide a flange for coupling to a topshell frame (not shown). A central hub 107 extends circumferentially around axis 115 and is positioned radially inside shell wall 101 towards the axially lowermost end 112. Hub 107 is supported and held in position within shell wall 101 via a plurality of support arms 106 that extends radially between a radially outermost region 110 of the hub 107 and a radially inward facing surface 103 of shell wall 101.

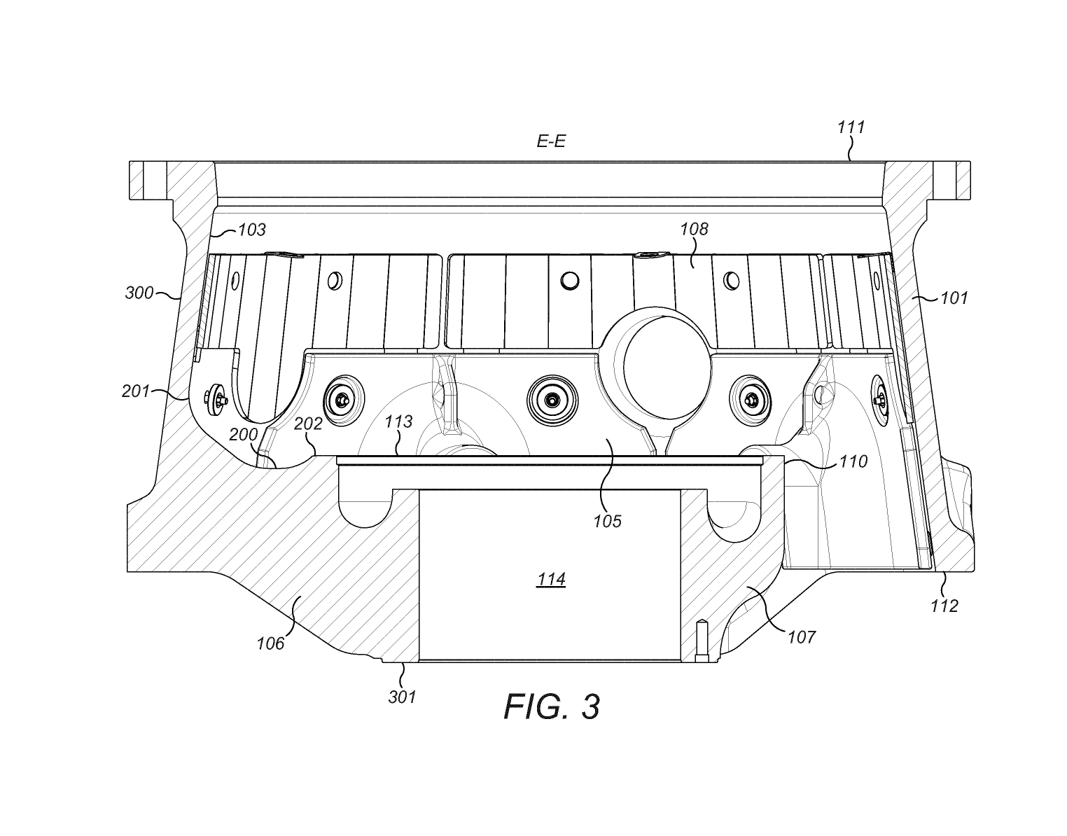

Hub 107 comprises a central cavity 114 aligned axially with axis 115 to receive a gyratory crusher main shaft (not shown) and to support the shaft towards its lowermost end for gyroscopic procession within the crusher. Hub 107 comprises an uppermost annular end surface 113 and an annular lowermost end surface 301 (referring to FIG. 3), with end surfaces 113, 301 realigned substantially parallel and perpendicular to axis 115. Upper end surface 113 represents an uppermost part of hub 107 that is positioned generally within an axial lower half of shell 100 between upper and lower ends 111, 112.

Shell wall 101 and in particular radially inward facing wall surface 103 defines an internal chamber 104 that represents a discharge region through which material falls having been crushed between the opposed radially outer and inner crusher shells (not shown) positioned generally within the topshell (not shown). So as to protect shell surface 103 from the discharged material, a modular wear resistant liner assembly 108 is secured at inner surface 103 via attachment bolts 116. The liner assembly 108 further comprises respective support arm liners 105 that have a first component that extends over a region of the shell inner surface 103 and a further component that extends radially over and about each support arm 106. Arm liners 105 are also secured primarily by a pair of attachment bolts 109 that extend through liner 105 and shell wall 101.

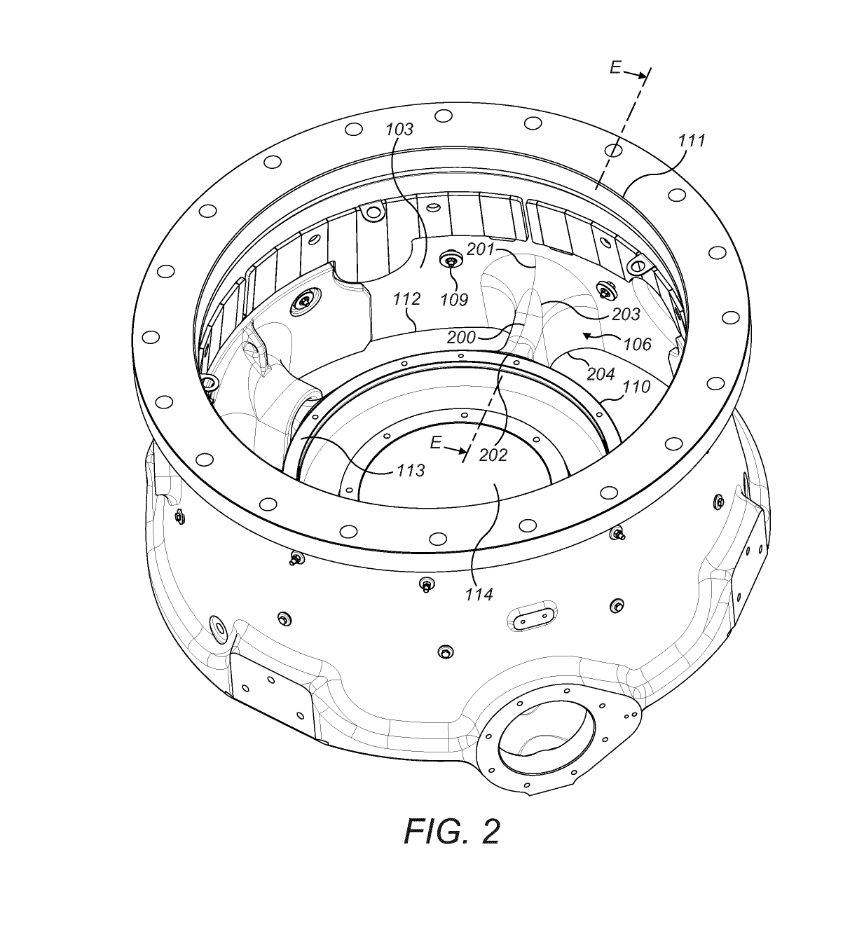

FIGS. 2 and 3 illustrate the bottom shell 100 of FIG. 1 with one of the support arm liners 105 removed for illustrative purposes. Each support arm 106 comprises an axially uppermost region, represented by an upward facing surface 203, and an axially lowermost region 204. The upward facing surface 203 extends radially between shell inner surface 103 and the radially outermost part 110 of hub 107. Arm surface 203 comprises a radially outer region 201 located at shell inner surface 103 and a radially inner region 202 positioned at the outermost region 110 of hub 107. A seat 200 is positioned radially between regions 201 and 202 and is formed as a saddle or axially extending depression at the arm surface 203. Accordingly, seat 200 is positioned axially lower than the annular uppermost end surface 113 of hub 107. That is, in a direction radially inward from the axially lowermost part of seat 200, the upward facing arm surface 203 curves axially upward at region 202 to meet hub uppermost surface 113. In the opposite radial direction from the seat 200, the uppermost surface 203 slopes axially upward towards radially outermost region 201 to provide a smooth curving transition onto the shell inner surface 103. Accordingly, a radially outermost region of arm upper surface 203 slopes axially downward from shell inner surface 103 to seat 200 and then curves or slopes axially upward from seat 200 to the uppermost end surface 113 of hub 107. Each arm 106 comprises an axial thickness or length extending below the axial length of hub 107 defined between uppermost annular end surface 113 and lowermost annular end surface 301.

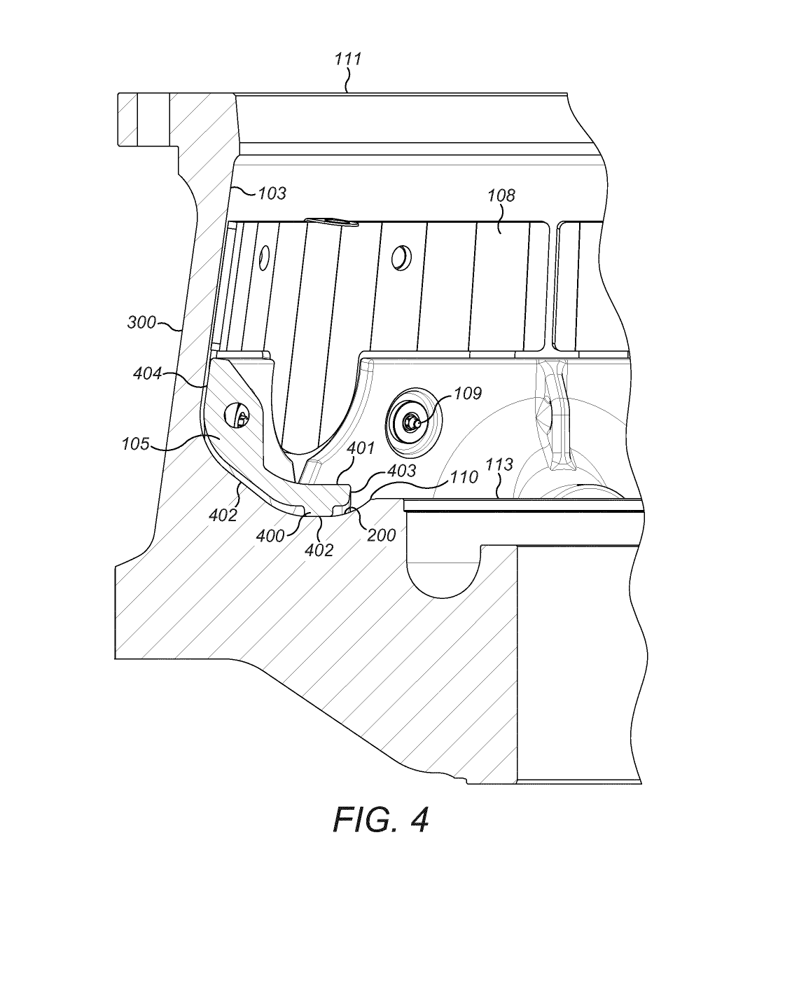

Referring to FIG. 4, each support arm liner 105 comprises a radially outermost region 404 for positioning in contact or near touching contact with shell inner surface 103. Liner 105 further comprises a radially innermost region 403 for positioning towards hub upper surface 113 and in particular the radially outermost end 110 of upper surface 113. An axially lowermost surface 402 of liner 105 is positioned opposed to the upward facing arm surface 203 whilst surface 401 of liner 105 is upward facing towards uppermost annular end 111 of shell wall 101. According to the preferred embodiment, at least a region of upward facing liner surface 401 is aligned substantially perpendicular to axis 115 to be approximately horizontal when the crusher is orientated in normal operational use. This is advantageous to avoid deflecting large volumes of crushed material falling through bottom shell 100 towards central hub 107.

Arm liner 105 comprises a locating foot 400 formed as a stub-projection extending axially downward from downward facing surface 402 and positioned radially towards the radially innermost end 403. Foot 400 is configured for positioning in contact with arm seat 200 such that liner 105 may be supported exclusively by contact between foot 400 and seat 200. In particular, seat 200 comprises an axial depth sufficient to accommodate the entire volume of foot 400 and a proportion of a lower region of the liner 105 generally. The curved profile of the arm upper surface 203, at the region of seat 200 is advantageous to allow liner 105 to be self-seating (by contact with the seat 200) such that if the primary attachment bolts 109 fail, liner 105 is maintained in position over and about arm 106. Additionally, the present configuration is further advantageous in that a radial length of seat 200 is optimised such that a significant volume of the liner 105 is accommodated within the seat (or recess) region to effectively axially lower the mass centre of liner 105 relative to uppermost surface 113. This is beneficial to prevent the liner 105 from being dislodged from arm 106 by the falling material.

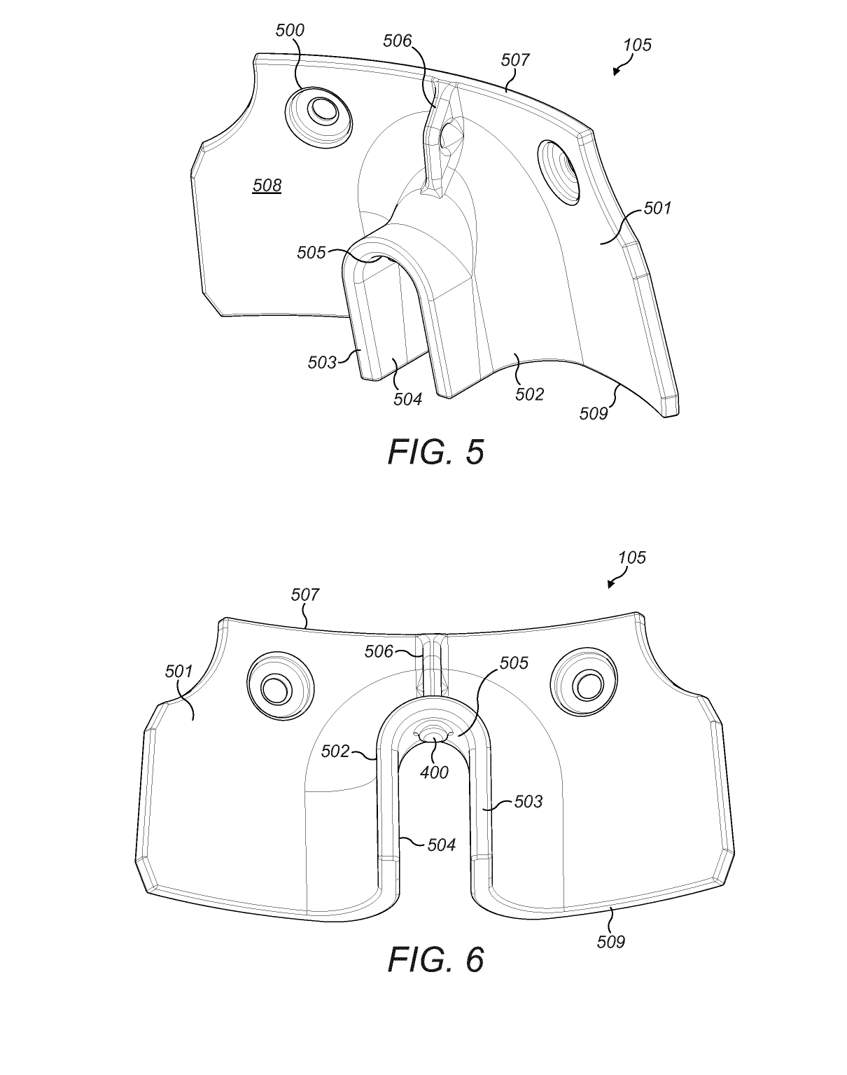

Referring to FIGS. 5 and 6, each liner 105 comprises a first part 501 for positioning at (and configured to protect) shell inner surface 103. First part 501 comprises a pair of holes 500 through which the attachment bolts 109 pass to secure liner 105 to surface 103. A second part 502 of liner 105 is formed as a short tunnel section 504 that projects perpendicular or tangential to first part 501 and is configured for positioning over and about support arm 106 and in particular upper surface 203. The tunnel part 504 comprises an arched entrance edge and surface 503 and an underside surface 505 positionable opposed to arm surface 203. Foot 400 projects downwardly from underside surface 505 within tunnel region 504 at a position towards arched edge 503. The second part 502 is positioned substantially within an axially lower half of liner 105 and extends from a liner lowermost edge 509. A liner surface 508 is orientated radially inward towards axis 115 and curves axially upward from arched edge 503 towards liner uppermost edge 507 at the first part 501. A handle 506 projects radially from surface 508 at the uppermost edge 507 to allow convenient mounting and dismounting of liner 105 at support arm 106.

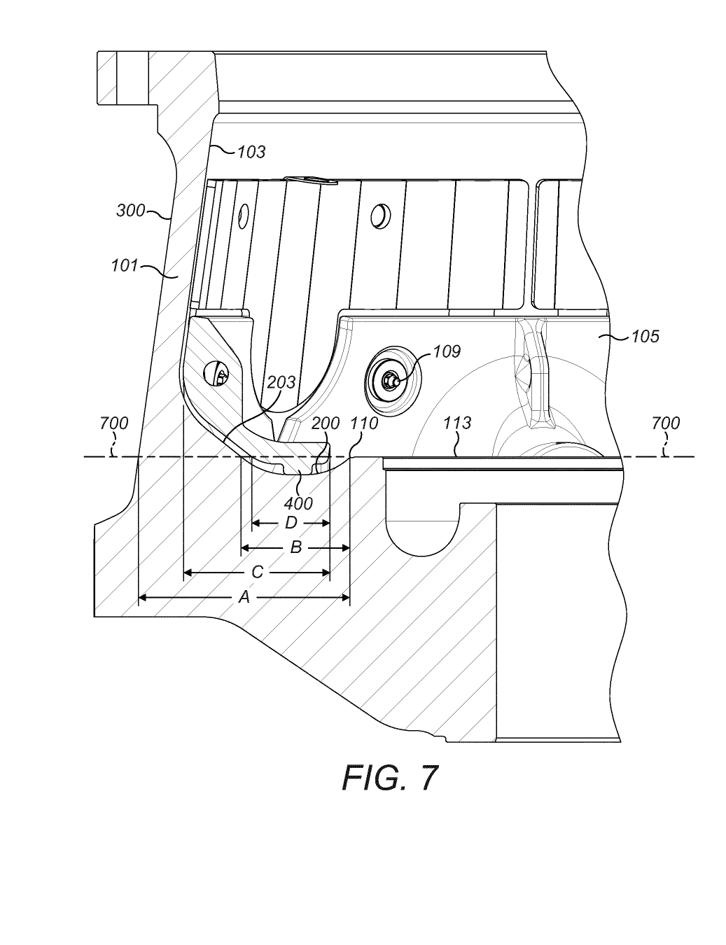

Referring to FIG. 7, the present bottom shell assembly is advantageous to distribute the mass of liner 105 between hub 107 and bottom shell wall 101 so as to reduce the tension and likelihood of failure at the primary attachment bolts 109. This is achieved by specifically configuring the dimensions of the region of seat 200 so as to accommodate and support an axially lowermost part of liner 105 at a region radially towards hub 107. Distance A corresponds to the radial distance between shell outer surface 300 and the radially outermost region 110 of hub upper surface 113 in a plane 700 aligned coplanar with uppermost surface 113. Distance B corresponds to the radial distance at plane 700 between the radially outermost region 110 of surface 113 and the region of arm upward facing surface 203 that bisects plane 700. Distance B therefore corresponds to the radial length of seat 200 that is positioned axially below hub uppermost surface 113. Distance C represents the radial length of liner 105 between the radially innermost end 403 and radially outermost end 404 (referring to FIG. 4). Distance D corresponds to the radial distance over which liner 105 is accommodated within seat 200 representing the volume of liner 105 that is positioned axially between plane 700 and the axially lowermost part of seat 200.

According to the specific implementation, at plane 700, the radial length B of seat 200 is substantially 50 to 60% of the radial distance A between the shell wall outer surface 300 and region 110 of hub surface 113. Additionally, at plane 700, the radial length B of seat 200 is substantially 70 to 80% of the radial length C of liner 105 between ends 403, 404. Furthermore, at plane 700, the radial length B of liner 105 occupied within seat 200 is 45 to 55%.

An axial depth of seat region 200 relative to hub uppermost surface 113 is optimised to provide both the correct support and seating of liner 105 at arm 106 and to avoid material collecting at the uppermost region of the hub. Accordingly, the axial depth of seat region 200 is such that the upward facing liner surface 401 is positioned axially above hub uppermost surface 113. The radially innermost liner end 403 is separated by a small radial distance from hub region 110 (at upper surface 113) to provide a desired radial clearance between liner 105 and hub 107. However, according to further embodiments, radially inner liner region 403 may be positioned at or in near touching contact with hub region 110.

Additionally, and according to further embodiments, the shape profile of arm upper surface 203 may comprise planar or angled regions so as to optimise seating of liner 105. Additionally, liner 105 may be devoid of the downwardly extending foot 400 such that the innermost surface 505 of tunnel region 504 may contact arm surface 203 at seat 200. Additionally, according to further embodiments, liner 105 may comprise a plurality of feet 400 projecting from surface 505 to contact arm surface 203 at seat 200.

1. A gyratory crusher bottom shell assembly comprising:
an outer wall extending around a longitudinal axis, the wall having radially outer and inner facing surfaces;
an inner hub positioned radially within the wall and surrounded by a part of the inner facing surface;
a plurality of support arms extending radially to connect the wall and the hub, each arm having an axially upward facing surface that extends generally axially downward from the inner facing surface of the wall towards the hub at a radially outer section of the arm, the upward facing surface at a radially inner section of the arm extending generally axially upward to mate with the hub wherein a region of the upward facing surface is positioned axially lower than an axially uppermost end surface of the hub to define a seat; and
a plurality of arm liners positioned over the respective arms, each liner having an upward facing surface arranged to contact material passing through the bottom shell assembly and an underside surface positioned opposed to the upward facing surface of the arm, each of the liners having a shape and configuration such that a part of the underside surface of the liner contacts the upward facing surface of the arm at the seat to at least partially mount each of the liners at a respective arm.

2. The assembly as claimed in claim 1, wherein in an axial plane extending along the radial length of each arm, a radial length of the seat is in a range 30 to 90% of a radial distance between a radially outermost part of the uppermost end surface of the hub and the outer facing surface of the wall at an axial position coplanar with said uppermost end surface.

3. The assembly as claimed in claim wherein the range is 40 to 80%.

4. The assembly as claimed in claim 3, wherein the range is 45 to 65%.

5. The assembly as claimed in claim 4, wherein the seat has a curved shape profile in a radial direction between the wall and the hub.

6. The assembly as claimed in claim 5, wherein the seat is positioned radially closer to the hub than the wall.

7. The assembly as claimed in claim 1, wherein in an axial plane extending along a radial length of each arm, a radial length of the seat is in a range 50 to 100% of a radial length of the respective liner extending in a direction between the wall and the hub.

8. The assembly as claimed in claim 7, wherein said range of said length of the seat to the length of the liner is 65 to 90%.

9. The assembly as claimed in claim 1, wherein in an axial plane extending along a radial length of each arm, a radial length of the liner occupied within the seat is in a range 10 to 80%.

10. The assembly as claimed in claim 9, wherein the radial length of the liner occupied within the seat is in the range 30 to 70%.

11. The assembly as claimed in claim 9, wherein the radial length of the liner occupied within the seat is in the range 40 to 60%.

12. A gyratory crusher bottom shell comprising:
an outer wall extending around a longitudinal axis, the wall having radially outer and inner facing surfaces;
an inner hub positioned radially within the wall and surrounded by a part of the inner facing surface;
a plurality of support arms extending radially to connect the wall and the hub, each arm having an axially upward facing surface that extends generally axially downward from the inner facing surface of the wall towards the hub at a radially outer section of the arm, the upward facing surface at a radially inner section of the arm extending generally axially upward to mate with the hub, wherein a region of the upward facing surface is positioned axially lower than an axially uppermost end surface of the hub to define a seat; and
in an axial plane extending along the radial length of each arm, a radial length of the seat is in a range 30 to 90% of a radial distance between a radially outermost part of the uppermost end surface of the hub and the outer facing surface of the wall at an axial position coplanar with said uppermost end surface.

13. The bottom shell as claimed in claim 12, wherein the range is 40 to 80%.

14. The bottom shell as claimed in claim 13, wherein the range is 45 to 65%.

15. The bottom shell as claimed in claim 14, wherein the seat is positioned radially closer to the hub and the wall and the seat has a curved shape profile in a radial direction between the wall and the hub.
